(19) United States
(12) Patent Application Publication
(10) Pub. No.: US 2025/0362715 A1
(43) Pub. Date: Nov. 27, 2025

(54) Method and Related Apparatus for Detecting a Rotation Angle of a Foldable Device

(71) Applicant: Robert Bosch GmbH, Stuttgart (DE)

(72) Inventors: Jie Cheng, Shanghai (CN); Huixia Zhao, Shanghai (CN); Xueqian Song, Shanghai (CN)

(21) Appl. No.: 19/214,910

(22) Filed: May 21, 2025

(30) Foreign Application Priority Data
May 23, 2024 (CN) 2024 1064 9690.7

(51) Int. Cl. G06F 1/16; G01B 7/30

(52) U.S. Cl. CPC G06F 1/1677; G01B 7/30

(57) ABSTRACT

A method for detecting a rotation angle of a foldable device is disclosed. The foldable device includes a first movable part and a second movable part that rotate through a connecting member. The method includes (i) obtaining a first rotation speed of the first movable part and a second rotation speed of the second movable part, (ii) determining whether the difference between the first rotation speed and the second rotation speed is higher than a first difference threshold, and (iii) determining a rotation angle between the first movable part and the second movable part based on the first rotation speed and the second rotation speed if the difference between the first rotation speed and the second rotation speed is higher than the first difference threshold. The rotation angle is calculated when the rotation speed difference between the two movable parts meets a threshold condition. This approach helps avoid the rotation angle within a certain error range caused by the zero point offset and sensitivity deviation of sensors when the opening angle between the two movable parts should remain unchanged. As a result, the accuracy of the opening angle is improved, enhancing the user experience of the foldable device.

This application claims priority under 35 U.S.C. § 119 to application no. CN 2024 1064 9690.7, filed on May 23, 2024 in China, the disclosure of which is incorporated herein by reference in its entirety.

Examples of the present disclosure generally relate to the field of electronic devices, and specifically to a method and a related apparatus for detecting a rotation angle of a foldable device.

### BACKGROUND

As user demands for portability and interactivity increase, foldable devices have experienced significant growth trend in the past period of time and are expected to remain a focal point in the electronic device sector in the future. These foldable devices include, for example, mobile phones and tablet computers with foldable screens.

Unlike conventional devices, foldable devices can exist in multiple states; for instance, a foldable mobile phone can be fully open, half open, or closed. The display mode of the screen varies with each state. To ensure an optimal user experience, it is crucial to accurately identify the state of the foldable device, particularly the opening angle of the foldable device.

### SUMMARY

Examples of the present disclosure provide a method and a related apparatus for detecting a rotation angle of a foldable device.

In a first aspect of the present disclosure, a method for detecting a rotation angle of a foldable device is provided, wherein the foldable device comprises a first movable part and a second movable part that rotate through a connecting member. The method comprises obtaining a first rotation speed of the first movable part and a second rotation speed of the second movable part. The method further comprises determining whether the difference between the first rotation speed and the second rotation speed is higher than a first difference threshold. Furthermore, the method also comprises responding when the difference between the first rotation speed and the second rotation speed is higher than the first difference threshold and determining a rotation angle between the first movable part and the second movable part based on the first rotation speed and the second rotation speed.

In a second aspect of the present disclosure, an apparatus for detecting a rotation angle of a foldable device is provided, wherein the foldable device comprises a first movable part and a second movable part that rotate through a connecting member. The apparatus comprises a rotation speed acquisition module configured to acquire a first rotation speed of the first movable part and a second rotation speed of the second movable part. The apparatus further comprises a difference comparison module configured to determine whether the difference between the first rotation speed and the second rotation speed is higher than a first difference threshold. Furthermore, the apparatus also comprises a rotation angle determination module configured to respond when the difference between the first rotation speed and the second rotation speed is higher than the first difference threshold and determine a rotation angle between the first movable part and the second movable part based on the first rotation speed and the second rotation speed.

In a third aspect of the present disclosure, a controller is provided. The controller comprises at least one processor. The controller further comprises a memory coupled to the at least one processor and having instructions stored thereon, wherein the instructions, when executed by the at least one processor, cause the controller to perform the method provided according to the first aspect.

In a fourth aspect of the present disclosure, a foldable device is provided. The foldable device comprises a first movable part and a second movable part that rotate through a connecting member. The foldable device further comprises a first gyroscope disposed on the first movable part and a second gyroscope disposed on the second movable part. The foldable device further comprises a first acceleration sensor disposed on the first movable part and a second acceleration sensor disposed on the second movable part. The foldable device further comprises a magnetic sensor disposed on the first movable part and a permanent magnet disposed on the second movable part. Furthermore, the foldable device also comprises the controller provided according to the third aspect.

In a fifth aspect of the present disclosure, a machine program product is provided, comprising a machine program which is executed by a processor to implement the method provided according to the first aspect.

In a sixth aspect of the disclosure, a machine-readable storage medium is provided. The machine-readable storage medium has machine-executable instructions stored thereon, wherein the machine-executable instructions are executed by a processor to implement the method provided according to the first aspect of the present disclosure.

It will be understood that the content described in the Summary is not intended to limit key or important features of the examples of the present disclosure, nor is it intended to limit the scope of the present disclosure. Other features of the present disclosure will become readily understood by the following description.

### BRIEF DESCRIPTION OF THE DRAWINGS

Above and other features, advantages and aspects of various examples of the present disclosure will become more apparent in combination with the accompanying drawings and with reference to the following detailed description. In the accompanying drawings, like or similar accompanying drawings designate like or similar elements, wherein:

FIG. 1 is a schematic diagram of a foldable device in which some examples of the present disclosure may be implemented;

FIG. 2A is a schematic diagram of a foldable device in some examples of the present disclosure;

FIG. 2B is a schematic diagram of another foldable device in some examples of the present disclosure;

FIG. 3 is a flow chart of a method for detecting a rotation angle of a foldable device in some examples of the present disclosure;

FIG. 4 is a schematic diagram of a process for determining a rotation angle of a foldable device in some examples of the present disclosure;

FIG. 5 is a schematic diagram of a process for determining an angle of a foldable device in some examples of the present disclosure;

FIG. 6 is a schematic diagram of a process for disabling a gyroscope in some examples of the present disclosure;

FIG. 7 is a block diagram of an apparatus for detecting a rotation angle of a foldable device in some examples of the present disclosure; and

FIG. 8 is a schematic block diagram of a controller in some examples of the present disclosure.

In all figures, like or similar reference numerals represent like or similar elements.

### DETAILED DESCRIPTION

The examples of the present disclosure will be described in further detail below with reference to the accompanying drawings. While certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples of the present disclosure, the term “comprise” and other similar expressions should be understood as open-ended inclusion, that is, “comprising but not limited to”. The term “based on” should be understood as “at least partially based on”. The term “one example” or “this example” should be understood as “at least one example”. The terms “first”, “second”, etc. may refer to and represent different or the same object. Other explicit and implicit definitions may be included below.

As mentioned above, accurately identifying the state of a foldable device is an important prerequisite for ensuring the user experience. In order to determine the state of a foldable device, it is necessary to detect its opening angle. In this regard, a sensor is provided in each of the two movable parts of the foldable device, and the rotation angles of the two movable parts of the foldable device are detected by the two sensors. However, due to the deviation of the zero point offset and sensitivity between the two sensors, when the opening angle between the two movable parts remains unchanged (that is, the rotation angles of the two movable parts should be exactly the same), it may be detected that the rotation angles of the two movable parts are different, resulting in a change in the opening angle, thereby causing an error in the opening angle.

To this end, a method for detecting a rotation angle of a foldable device is provided in examples of the present disclosure. The rotation speeds of two movable parts are collected, and a threshold judgment is performed on the rotation speed difference of the two movable parts. When the difference is higher than the difference threshold, the rotation angle between the two movable parts is determined based on the rotation speeds of the two movable parts. In this way, the rotation angle is calculated when the rotation speed difference between the two movable parts meets a threshold condition. This approach helps avoid the rotation angle within a certain error range caused by the zero point offset and sensitivity deviation of sensors when the opening angle between the two movable parts should remain unchanged. As a result, the accuracy of the opening angle is improved, enhancing the user experience of the foldable device.

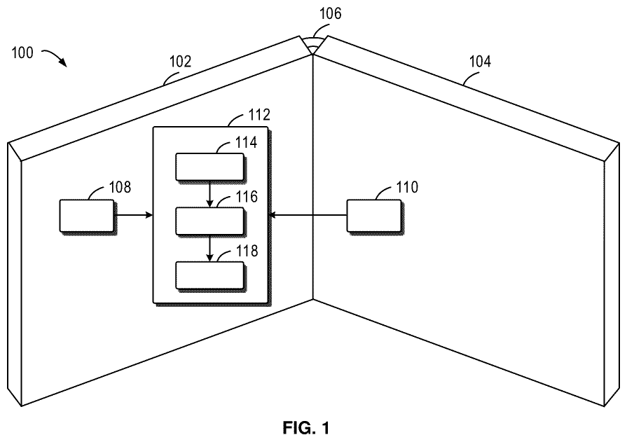

FIG. 1 is a schematic diagram of a foldable device 100 in which some examples of the present disclosure may be implemented. In some examples, a foldable device 100 comprises a movable part 102 (which may be referred to as a first movable part), a movable part 104 (which may be referred to as a second movable part), and a connecting member 106, wherein the movable part 102 and the movable part 104 are connected and rotated through the connecting member 106. Referring to FIG. 1, the movable part 102 and the movable part 104 are connected by short sides, and when the foldable device 100 is fully opened, the opening angle between the movable part 102 and the movable part 104 is 180 degrees, and when the foldable device 100 is closed, the opening angle between the movable part 102 and the movable part 104 is 0. It should be understood that the opening angle in the present disclosure refers to the angle formed by the plane of the movable part 102 and the plane of the movable part 104 at a certain point in time, and the rotation angle refers to the angle at which the angle between the plane of the movable part 102 and the plane of the movable part 104 changes from one point in time to another.

In some examples, the foldable device 100 comprises a foldable mobile phone connected by short sides, and the fronts of the movable part 102 and the movable part 104 respectively comprise a first part and a second part of the main screen of the foldable mobile phone, and the back of the movable part 102 may further comprise a sub-screen of the foldable mobile phone. When the foldable mobile phone is fully opened or half-opened, the main screen is displayed, and when the foldable mobile phone is fully closed, the sub-screen is displayed. Therefore, the display state of the foldable mobile phone is determined based on the opening angle of the foldable mobile phone. In some examples, the connecting member 106 is a hinge structure.

In some examples, the movable part 102 and the movable part 104 are respectively provided with a sensor 108 and a sensor 110, and the sensor 108 and the sensor 110 are respectively used to collect rotation speed of the movable part 102 (which may be referred to as the first rotation speed) and the rotation speed of the movable part 104 (which may be referred to as the second rotation speed). Then, the sensor 108 and the sensor 110 respectively send the rotation speed of the movable part 102 and the rotation speed of the movable part 104 to a controller 112 provided on the movable part 102. It should be understood that this example is merely exemplary, and the controller 112 in the present disclosure may also be provided on the movable part 104, or provided on both the movable part 102 and the movable part 104.

The controller 112 comprises a rotation speed receiving unit 114, a difference comparison unit 116, and a rotation angle calculation unit 118. The rotation speed receiving unit 114 receives the rotation speed of the movable part 102 and the rotation speed of the movable part 104 from the sensor 108 and the sensor 110. The difference comparison unit 116 determines the rotation speed difference according to the rotation speed of the movable part 102 and the rotation speed of the movable part 104, and compares the rotation speed difference with a difference threshold (which may be referred to as a first difference threshold). If the rotation speed difference is higher than the difference threshold, the rotation angle calculation unit 118 calculates the rotation angle between the movable part 102 and the movable part 104 according to the rotation speed of the movable part 102 and the rotation speed of the movable part 104.

In this example, the rotation speeds of the movable part 102 and the movable part 104 are collected, and a threshold judgment is performed on the rotation speed difference between the movable part 102 and the movable part 104. When the difference is higher than the difference threshold, the rotation angle between the movable part 102 and the movable part 104 is determined based on the rotation speeds of the movable part 102 and the movable part 104. In this way, the rotation angle is calculated when the rotation speed difference between the movable part 102 and the movable part 104 meets the threshold condition. This approach helps avoid the rotation angle within a certain error range caused by the zero point offset and sensitivity deviation of the sensor 108 and the sensor 110 when the opening angle between the movable part 102 and the movable part 104 should remain unchanged. As a result, the accuracy of the opening angle is improved, enhancing the user experience of the foldable device 100.

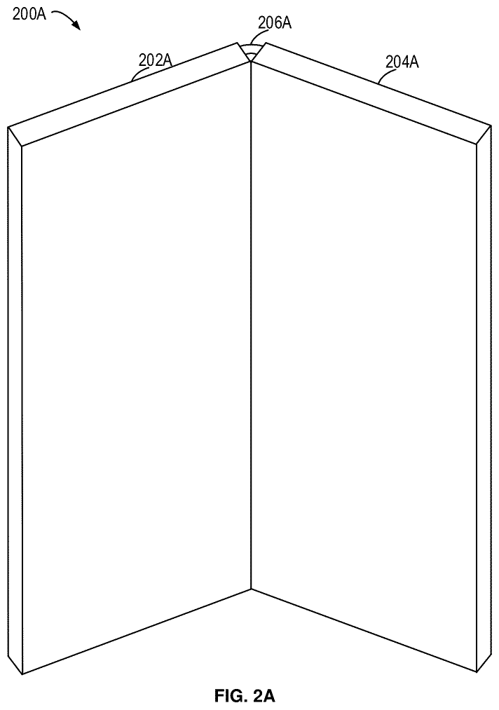

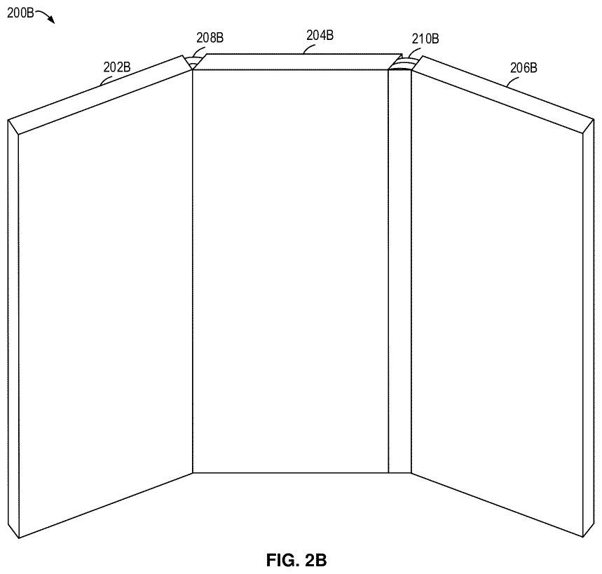

It should be understood that the architecture and functions of the foldable device 100 are described for exemplary purposes only, without implying any limitation to the scope of the present disclosure. The examples of the present disclosure may also be applied to other foldable devices having different structures and/or functions, such as the foldable device 200A shown in FIG. 2A and the foldable device 200B shown in FIG. 2B.

FIG. 2A is a schematic diagram of a foldable device 200A in some examples of the present disclosure. In some examples, the foldable device 200A comprises a movable part 202A (which may be referred to as a first movable part), a movable member 204A (which may be referred to as a second movable part), and a connecting member 206A, wherein the movable part 202A and the movable part 204A are connected by long sides. In some examples, the foldable device 200A is a foldable mobile phone in a form connected by long sides.

FIG. 2B is a schematic diagram of another foldable device 200B according to some examples of the present disclosure. In some examples, the foldable device 200B comprises a movable part 202B, a movable part 204B, and a movable part 206B. The movable part 202B and the movable part 204B are connected and rotated through a connecting member 208B, and the movable part 204B and the movable part 206B are connected and rotated through a connecting member 210B. The movable part 202B and the movable part 204B, and the movable part 204B and the movable part 206B are connected by long sides.

When determining the rotation angle between the movable part 202B and the movable part 204B, the movable part 202B may be referred to as a first movable part and the movable part 204B may be referred to as a second movable part, and then the rotation angle between the movable part 202B and the movable part 204B may be determined by the method disclosed in the present disclosure. Similarly, when determining the rotation angle between the movable part 204B and the movable part 206B, the movable part 204B may be referred to as a first movable part and the movable part 206B may be referred to as the second movable part, and then the rotation angle between the movable part 204B and the movable part 206B may be determined by the method disclosed in the present disclosure. Therefore, the number of movable parts of the foldable device in the present disclosure may be two, or three or more. For any two adjacent movable parts of the foldable device, the rotation angle between the two movable parts may be calculated by the disclosed method.

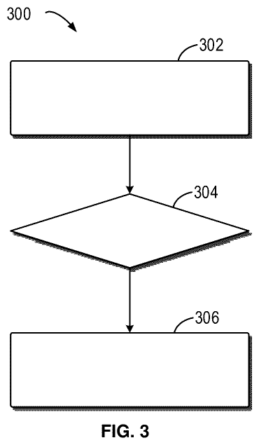

The process according to examples of the present disclosure will be described in detail below in conjunction with FIG. 3 to FIG. 8. For ease of understanding, the specific data mentioned in the following description are exemplary and are not used for defining the scope of protection of the present disclosure. It should be understood that the examples described below may also comprise additional actions not shown and/or actions that may be omitted as shown, the scope of the present disclosure being not limited in this regard.

FIG. 3 is a flow chart of a method 300 for detecting a rotation angle of a foldable device in some examples of the present disclosure. In some examples, in the foldable device 100 shown in FIG. 1, the foldable device 100 comprises a movable part 102 (which may be referred to as a first movable part) and a movable part 104 (which may be referred to as a second movable part) that rotate through a connecting member 106, and the method 300 may be executed by a controller 112. It should be understood that although the following content is described with the controller 112 as the execution subject, the method 300 may also be executed by other devices. The method 300 may further comprise additional actions not shown and/or actions that may be omitted as shown, the scope of the present disclosure being not limited in this regard.

At 302, a first rotation speed of the first movable part and a second rotation speed of the second movable part are obtained. In some examples, the rotation speed of the movable part 102 (which may be referred to as a first rotation speed) and the rotation speed of the movable part 104 (which may be referred to as a second rotation speed) are respectively collected by the sensor 108 disposed at the movable part 102 and the sensor 110 disposed at the movable part 104. Then, the controller 112 obtains the rotation speed of the movable part 102 and the rotation speed of the movable part 104 from the sensor 108 and the sensor 110.

At 304, it is determined whether the difference between the first rotation speed and the second rotation speed is higher than a first difference threshold. In some examples, after the controller 112 obtains the rotation speed of the movable part 102 and the rotation speed of the movable part 104, it calculates the rotation speed difference between the movable part 102 and the movable part 104, and compares the rotation speed difference with a preset difference threshold (which may be referred to as a first difference threshold) to determine whether the difference is higher than the difference threshold.

At 306, if the difference between the first rotation speed and the second rotation speed is higher than the first difference threshold, the rotation angle between the first movable part and the second movable part is determined based on the first rotation speed and the second rotation speed. In some examples, after the controller 112 determines that the rotation speed difference between the movable part 102 and the movable part 104 is higher than the difference threshold, the rotation angle between the movable part 102 and the movable part 104 is calculated based on the rotation speed of the movable part 102 and the rotation speed of the movable part 104. In some examples, the rotation angle between the movable part 102 and the movable part 104 is the sum of the angle rotated by the movable part 102 and the angle rotated by the movable part 104. In some examples, if the controller 112 determines that the rotation speed difference between the movable part 102 and the movable part 104 is lower than the difference threshold, it is determined that the rotation angle is caused by the zero point offset and sensitivity deviation between the sensor 108 and the sensor 110, and in fact, the opening angles of the movable parts 102 and 104 remain unchanged. At this time, the controller 112 determines that there is no rotation angle.

In the examples of the present disclosure, the rotation speeds of two movable parts are collected, and a threshold judgment is performed on the rotation speed difference of the two movable parts. When the difference is higher than the difference threshold, the rotation angle between the two movable parts is determined based on the rotation speeds of the two movable parts. In this way, the rotation angle is calculated when the rotation speed difference between the two movable parts meets a threshold condition. This approach helps avoid the rotation angle within a certain error range caused by the zero point offset and sensitivity deviation of sensors when the opening angle between the two movable parts should remain unchanged. As a result, the accuracy of the opening angle is improved, enhancing the user experience of the foldable device.

In some examples, referring to FIG. 1, if the controller 112 determines that the rotation speed difference between the movable part 102 and the movable part 104 is lower than the difference threshold, the controller 112 further compares the rotation speed difference between the movable part 102 and the movable part 104 with the other difference threshold (which may be referred to as a second difference threshold), and compares the first-order derivative of the rotation speed difference (which may be referred to as a rate of change) with a derivative threshold (which may be referred to as a rate of change threshold). If the rotation speed difference between the movable part 102 and the movable part 104 is lower than the other difference threshold, or the first-order derivative of the rotation speed difference is lower than the derivative threshold, it is determined that the rotation angle of the foldable device 100 is 0 (i.e., the rotation angle does not exist).

It should be understood that the other difference threshold (the second difference threshold) is less than or equal to the aforementioned difference threshold (the first difference threshold). In this way, when the rotation speed difference between the movable part 102 and the movable part 104 is very small or the rate of change of the rotation speed difference is very small, the rotation angle may be directly determined to be 0 (i.e., the opening angle between the movable part 1 and the movable part 2 is not adjusted), so that the rotation speeds of the movable part 102 and the movable part 104 are filtered in this case, thereby avoiding the deviation of the opening angle between the movable part 102 and the movable part 104 caused by the zero point offset and sensitivity error between the sensor 108 and the sensor 110. As a result, the accuracy of the opening angle is improved.

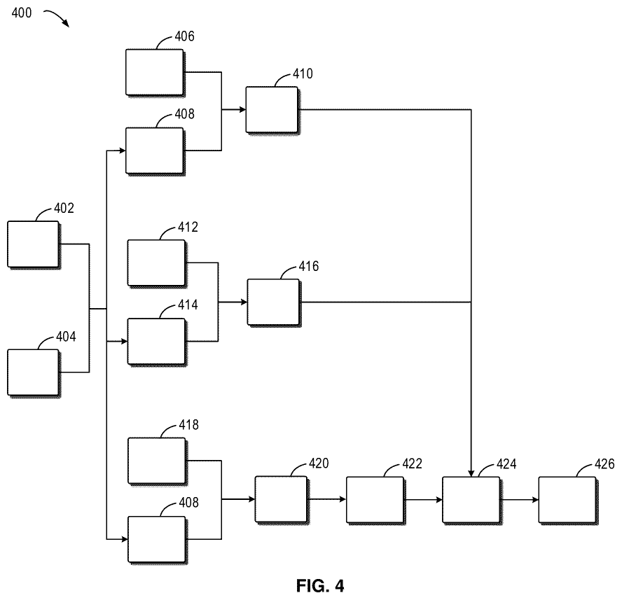

FIG. 4 is a schematic diagram of a process 400 for determining a rotation angle of a foldable device in some examples of the present disclosure. In some examples, in the foldable device 100 shown in FIG. 1, the process 400 may be performed by the controller 112. It should be understood that although the following content is described with the controller 112 as the execution subject, the process 400 may also be performed by other devices. The method 400 may further comprise additional actions not shown and/or actions that may be omitted as shown, the scope of the present disclosure being not limited in this regard.

In some examples, the sensor 108 in the movable part 102 comprises a gyroscope 1 (which may be referred to as a first gyroscope), and the sensor 110 in the movable part 104 comprises a gyroscope 2 (which may be referred to as a second gyroscope). The gyroscope 1 is used to collect the angular velocity 402 (which may be referred to as a first angular velocity) of the movable part 102, and the gyroscope 2 is used to collect the angular velocity 404 (which may be referred to as a second angular velocity) of the movable part 104.

Under ideal conditions, the gyroscope 1 and the gyroscope 2 are two gyroscopes with completely identical parameter performance. However, under actual conditions, the gyroscope 1 and the gyroscope 2 often have deviations in zero point offset and sensitivity. This deviation can cause angular velocity deviation of the foldable device 110 in motion, thereby causing errors in the opening angles of the foldable device 100. For example, when the foldable device 100 is closed (at this time the opening angle is 0) and rotates as a whole at a certain angular velocity (e.g., 100 degrees/second), under theoretical conditions the opening angle of the foldable device 100 is always 0. However, due to the zero point offset and sensitivity deviation between the gyroscope 1 and the gyroscope 2, at this time, there is an angular velocity deviation (e.g., 0.2 degrees/second) between the angular velocity 402 detected by the gyroscope 1 (e.g., 100.3 degrees/second) and the angular velocity 404 detected by the gyroscope 2 (e.g., 100.5 degrees/second). This angular velocity deviation will cause an error in the calculated opening angle of the foldable device 100 (e.g., the opening angle increases by 0.2 degrees per second).

Referring to FIG. 4, in order to avoid the opening angle error of the foldable device 100 caused by the zero point offset and sensitivity deviation between the gyroscope 1 and the gyroscope 2, the controller 112 obtains the angular velocity 402 and the angular velocity 404, then calculates the angular velocity difference 408 between the angular velocity 402 and the angular velocity 404, compares the angular velocity difference 408 with a difference threshold 406 (which may be referred to as a second difference threshold), and obtains a threshold comparison result 410 and inputs it to a latch 424. At the same time, the controller 112 calculates the first-order derivative 414 (which may be referred to as the rate of change) of the angular velocity difference 408, compares the first-order derivative 414 with the derivative threshold 412 (which may be referred to as the rate of change threshold), and obtains the threshold comparison result 416 and inputs it to the latch 424. The controller 112 also compares the angular velocity difference 408 with a difference threshold 418 (which may be referred to as a first difference threshold) and obtains the threshold comparison result 420, inputs the threshold comparison result 420 into an inverter 422, and then inputs the result into the latch 424 based on the negation of the inverter 422.

When the controller 112 determines via the latch 424 that the angular velocity difference 408 is lower than the difference threshold 406 and the first-order derivative 414 is lower than the derivative threshold 412, the rotation angle between the movable part 102 and the movable part 104 is set to 0 (i.e., the opening angle between the movable part 102 and the movable part 104 is not adjusted). When the controller 112 determines via the latch 424 that the angular velocity difference 408 is higher than the difference threshold 418, an adjustment mark 426 is generated so that the controller 112 calculates the rotation angle between the movable part 102 and the movable part 104 through the angular velocity 402 and the angular velocity 404 when the adjustment mark 426 exists. (The rotation angle is used to adjust the opening angle between the movable part 102 and the movable part 104).

For example, the difference threshold 406 may be set to 0.3 degrees/second, the difference threshold 418 may be set to 2 degrees/second, and the derivative threshold 412 may be set to 0.1 degrees/second². When the controller 112 determines that the angular velocity difference 408 is lower than 0.3 degrees/second and the first-order derivative 414 is lower than 0.1 degrees/second², it indicates that the angular velocity difference 408 is not caused by the user opening the foldable device 100 normally, but is caused by the zero point offset and sensitivity deviation between the gyroscope 1 and the gyroscope 2. At this time, the opening angle between the movable part 102 and the movable part 104 does not actually change (that is, the rotation angle should be 0), and therefore the controller 112 directly determines the rotation angle as 0, thereby avoiding the influence of the zero point offset and sensitivity deviation between the gyroscope 1 and the gyroscope 2 on the opening angle.

When the controller 112 determines that the angular velocity difference 408 is higher than 2 degrees/second, it indicates that the angular velocity deviation 408 is caused by the user opening the foldable device 100 normally. At this time, the opening angle between the movable part 102 and the movable part 104 actually changes. Therefore, it is necessary to calculate the changed angle, that is, the rotation angle, based on the angular velocity 402 and the angular velocity 404, and then calculate the changed opening angle based on the rotation angle.

In some examples, the controller 112 may determine the time period during which the movable part 102 rotates (which may be referred to as a first time period) through the gyroscope 1, and determine the time period during which the movable part 2 rotates (which may be referred to as a second time period) through the gyroscope 2. Then, the controller 112 may integrate the angular velocity 402 over the time period during which the movable part 102 rotates to obtain the rotation angle of the movable part 102 (which may be referred to as a first rotation angle), and may integrate the angular velocity 404 over the time period during which the movable part 104 rotates to obtain the rotation angle of the movable part 104 (which may be referred to as a second rotation angle). Further, the controller 112 determines the rotation angle between the movable part 102 and the movable part 104 based on the sum of the rotation angle of the movable part 102 and the rotation angle of the movable part 104. It should be understood that the angular velocity is the differential result of the rotation angle with respect to time, and therefore the rotation angle between the movable part 102 and the movable part 104 may be calculated by integrating the collected angular velocity. In this way, the cost of calculating the rotation angle may be reduced.

In some examples, the gyroscope 1 or the gyroscope 2 may have an angular velocity offset. For example, when the foldable device 100 is in a stationary state, the angular velocity collected by the gyroscope 1 and the gyroscope 2 may not be 0. As time goes by, the controller 112 integrates a rotation angle based on the offset angular velocity, and the longer the time, the larger the rotation angle. However, in reality, the rotation angle of the foldable device 100 is always 0.

To solve the offset of the gyroscope 1 and the gyroscope 2, the sensor 108 in the movable part 102 further comprises an acceleration sensor 1 (which may be referred to as a first acceleration sensor), and the sensor 110 in the movable part 104 further comprises an acceleration sensor 2 (which may be referred to as a second acceleration sensor). Through the acceleration sensor 1 and the acceleration sensor 2, the controller 112 may determine whether the movable part 102 and the movable part 104 are in a stationary state. If the movable part 102 and the movable part 104 are in a stationary state, the controller 112 obtains an angular velocity compensation value for the gyroscope 1 (which may be referred to as a first compensation value) and the angular velocity compensation value for the gyroscope 2 (which may be referred to as the second compensation value). Then, the controller 112 corrects the angular velocity collected by the gyroscope 1 (which may be referred to as the first angular velocity) through the angular velocity compensation value of the gyroscope 1, and corrects the angular velocity collected by the gyroscope 2 (which may be referred to as the second angular velocity) through the angular velocity compensation value of the gyroscope 2.

In this way, when the foldable device 100 is in a stationary state, when an angular velocity offset occurs in the gyroscope 1 and the gyroscope 2, the angular velocity collected by the gyroscope 1 and the gyroscope 2 may be corrected by using the angular velocity compensation value, thereby improving the accuracy of the angular velocity of the movable part 102 and the movable part 104, and further improving the accuracy of the rotation angle.

In some examples, the controller 112 determines whether the movable part 102 is in a stationary state through the acceleration sensor 1. When the movable part 102 is in a stationary state, the angular velocity of the movable part 102 at multiple time points is collected through the gyroscope 1. Then, the controller 112 calculates the average value of the multiple angular velocities and uses the average value as the angular velocity compensation value of the gyroscope 1. It should be understood that when the movable part 102 is in a stationary state, its actual angular velocity is 0, and the angular velocity of the movable part 102 collected by the gyroscope 1 is essentially the offset angular velocity.

Similarly, the controller 112 determines whether the movable part 104 is in a stationary state through the acceleration sensor 2. When the movable part 104 is in a stationary state, the angular velocity of the movable member 104 at multiple time points is collected through the gyroscope 2. Then, the controller 112 calculates the average value of the multiple angular velocities and uses the average value as the angular velocity compensation value of the gyroscope 2. In this way, the offset values of the angular velocities at multiple time points may be collected, and then the angular velocity compensation value is determined based on the offset value, thereby improving the accuracy of the angular velocity compensation value.

In some examples, the movable part 102 is provided with a gyroscope 1, an acceleration sensor 1 and a magnetic sensor, and the movable part 104 is provided with a gyroscope 2, an acceleration sensor 2 and a permanent magnet. The gyroscope 1 and the gyroscope 2 are used to collect the angular velocity of the movable part 102 and the angular velocity of the movable part 104, and the controller 112 may determine the rotation angle between the movable part 102 and the movable part 104 based on the angular velocity of the movable part 102 and the angular velocity of the movable part 104, and then determine the opening angle. The acceleration sensor 1 and the acceleration sensor 2 may collect the acceleration of the movable part 102 and the acceleration of the movable part 104, and the controller 112 may determine the opening angle between the movable part 102 and the movable part 104 (which may be referred to as a first angle) based on the acceleration of the movable part 102 and the acceleration of the movable part 104. The magnetic sensor may collect the magnetic field strength based on the permanent magnet, and the controller 112 may determine the opening angle between the movable part 102 and the movable part 104 (which may be referred to as a second angle) based on the magnetic field strength.

It should be understood that, for the magnetic sensor, when the foldable device 100 is fully closed, the magnetic field strength collected by the magnetic sensor is the largest, and when the foldable device 100 is fully opened, the magnetic field strength collected by the magnetic sensor is the smallest. Therefore, the closer the foldable device is to the closed state, the more accurate the opening angle determined by the magnetic sensor is, and the closer the foldable device is to the fully opened state, the larger the error of the opening angle determined by the magnetic sensor is.

It should be understood that the acceleration sensor 1 and the acceleration sensor 2 may only collect the acceleration in the direction of gravity when the foldable device is stationary. When the foldable device 100 is placed flat on the desktop or at a small angle to the desktop, the acceleration sensor 1 and the acceleration sensor 2 may collect relatively accurate acceleration in the direction of gravity. At this time, the opening angle determined by the acceleration sensor 1 and the acceleration sensor 2 is relatively accurate. When the connecting member 106 of the foldable device 100 (or the rotation axis of the movable part 102 and the movable part 104) is more perpendicular to the desktop, the acceleration in the direction of gravity collected by the acceleration sensor 1 and the acceleration sensor 2 is smaller. At this time, the opening angle determined by the acceleration sensor 1 and the acceleration sensor 2 has a larger error.

It should be understood that when the angle between the direction of the connecting member 106 and the horizontal plane is close to 90 degrees, or when the opening angle between the movable part 102 and the movable part 104 is too large, it is difficult to determine the accurate opening angle through the acceleration sensor 1, the acceleration sensor 2 or the magnetic sensor. Therefore, it is necessary to combine the gyroscope 1 and the gyroscope 2 to determine the accurate opening angle. At the same time, since the gyroscope 1 and the gyroscope 2 collect the angular velocity of the movable part 102 and the movable part 104, the opening angle determined by the gyroscope 1 and the gyroscope 2 in a motion scene has higher accuracy.

Therefore, in different states of the foldable device 100, the accuracy of the opening angles determined by different sensors is also different. Based on this, the controller 112 may obtain the state of the foldable device 100. Then, the controller 112 selects one of the following: the opening angle determined by the magnetic sensor, the opening angle determined by the acceleration sensor, and the rotation angle determined by the gyroscope, according to the state of the foldable device 100, and then determines the final opening angle of the foldable device 100. In this way, the sensor that is more suitable for the current state may be selected according to the state of the foldable device 100, thereby improving the accuracy of the opening angles of the foldable device 100 in different states.

In some examples, when the controller 112 determines that the foldable device 100 is in a stationary state and the angle between the connecting member 106 and the horizontal plane is lower than an angle threshold, the opening angle of the foldable device 100 is determined as an angle determined by the acceleration sensor. When the controller 112 determines that the foldable device 100 is in a closed state, the angle of the foldable device 100 is determined as an angle determined by the magnetic sensor. When the controller 112 determines that the foldable device 100 is in motion, the opening angle of the foldable device 100 is determined based on the rotation angle determined by the magnetic sensor.

In some examples, the controller 112 may determine the opening angle of the foldable device 100 based on the rotation angle. When the foldable device 100 is in motion, the opening angle at the time when the foldable device 100 enters the motion state from the stationary state is obtained, and the rotation angle of the foldable device 100 from the motion state is calculated, and then the current opening angle of the foldable device 100 is calculated based on the sum or difference of the opening angle at the time when the foldable device enters the motion state and the rotation angle.

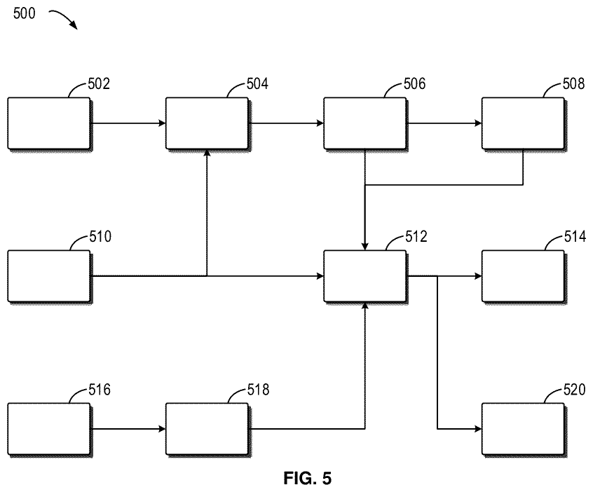

FIG. 5 is a schematic diagram of a process 500 for determining an angle of a foldable device in some examples of the present disclosure. In some examples, in the example environment 100 shown in FIG. 1, the process 500 may be performed by the controller 112. It should be understood that although the following content is described with the controller 112 as the execution subject, the process 500 may also be performed by other devices. The method 500 may further comprise additional actions not shown and/or actions that may be omitted as shown, the scope of the present disclosure being not limited in this regard.

In some examples, two gyroscopes 502, two acceleration sensors 510, and a magnetic sensor 516 are provided in the movable part 102 and the movable part 104. The two gyroscopes 502 are used to collect the angular velocity of the movable part 102 and the movable part 104, and the two acceleration sensors 510 are used to determine whether the movable part 102 and the movable part 104 are in a stationary state, so as to determine the opening angle according to the acceleration of the movable part 102 and the movable part 104. The magnetic sensor 516 is used to determine the magnetic field strength when the foldable device 100 is closed, so as to determine the opening angle of the movable part 102 and the movable part 104 based on the magnetic field strength.

When the movable part 102 and the movable part 104 are in a stationary state, the controller 112 performs angular velocity compensation on the angular velocity collected by the two gyroscopes 502 through an offset compensator 504. In some examples, the controller 112 determines whether the movable part 102 and the movable part 104 are in a stationary state through the two acceleration sensors 510, and compensates the angular velocity collected by the two gyroscopes 502 by a preset compensation value when the two movable parts are in a stationary state. Then, a computing device 112 processes the compensated angular velocity based on the online retrim algorithm 506.

In the online retrim algorithm 506, the controller 112 calculates the difference between the two compensated angular velocities, and compares the difference with an enter threshold (which may be referred to as the first difference threshold) and an exit threshold (which may be referred to as the second difference threshold), and compares the first-order derivative of the difference (which may be referred to as the rate of change) with the enter rate of change threshold (which may be referred to as the rate of change threshold). Moreover, the computing device 112 performs a logical judgment through a latch to determine whether to perform an integration process on the angular velocity to generate a rotation angle. When it is determined that the angular velocity is to be integrated, the computing device 112 integrates the angular velocity through an angle algorithm 508 to calculate the rotation angle of the movable part 102 and the movable part 104. If the angular velocity does not need to be integrated, the controller 112 directly determines that the rotation angle is 0. The specific steps of the threshold comparison in the online retrim algorithm 506 have been described in detail in the above example, and will not be repeated in this example.

Continuing to refer to FIG. 5, the controller 112 selects one of the following: the opening angle determined by the two acceleration sensors 510, the opening angle determined by the magnetic sensor 516, and the opening angle determined by the two gyroscopes 502 (the opening angle is determined based on the rotation angle) based on the state of the foldable device 100 by an angle fusion algorithm 512, thereby obtaining an opening angle output result 514. The specific process of the controller 112 selecting the opening angle according to the state of the foldable device has been described in detail in the above example, and will not be repeated in this example. Further, when the state of the foldable device 100 meets the condition, the controller 112 controls the foldable device 100 to enter a power saving mode 520, in which the two gyroscopes 502 are turned off.

Since the gyroscope consumes more power than the magnetic sensor and the acceleration sensor, keeping the gyroscope turned on all the time will increase the power burden of the foldable device 100. To this end, in some examples, the controller 112 may disable the gyroscope 1 and the gyroscope 2 when the foldable device 100 is in a stationary state or a closed state, and when multiple opening angles of the foldable device 100 at multiple time points remain stable (that is, the discrete degree meets the discrete condition). Furthermore, when the foldable device 100 is in motion, the gyroscope 1 and the gyroscope 2 are turned on. In this way, the opening angle may be determined by the magnetic sensor and the acceleration sensor when the foldable device 100 is in a non-motion state, and the opening angle may be determined by combining the gyroscope when the foldable device is in motion. While ensuring the accuracy of the opening angle, the use of the gyroscope may be reduced, thereby reducing the power burden of the foldable device 100.

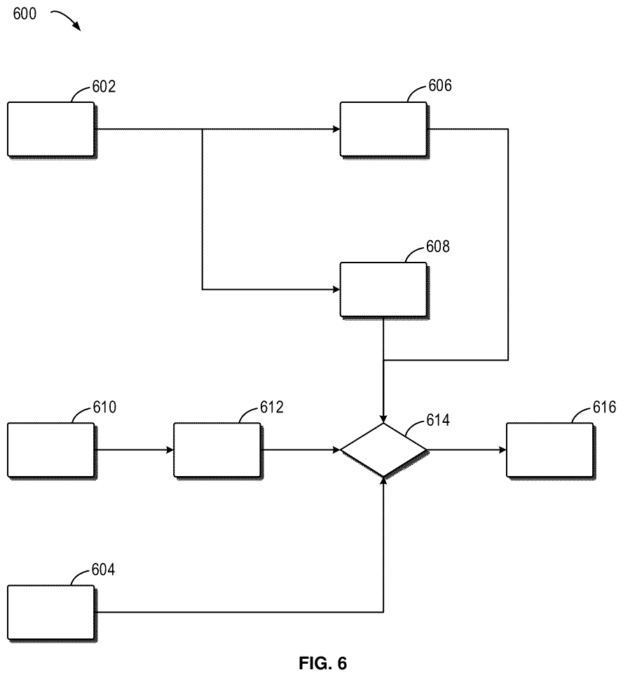

FIG. 6 is a schematic diagram of a process 600 for disabling a gyroscope in some examples of the present disclosure. In some examples, in the foldable device 100 shown in FIG. 1, the process 600 may be performed by the controller 112. It should be understood that although the following content is described with the controller 112 as the execution subject, the process 600 may also be performed by other devices. The method 600 may further comprise additional actions not shown and/or actions that may be omitted as shown, the scope of the present disclosure being not limited in this regard.

In some examples, the controller 112 determines the opening angles 602 of the foldable device 100 at multiple previous time points, and calculates the variance 606 and the average value 608 of the angles based on the multiple previous opening angles 604. In addition, the controller 112 further determines the state 612 (including the stationary state and the motion state) of the foldable device 100 by two acceleration sensors 610. Further, the controller 112 obtains the current opening angle 604 through the above-mentioned angle fusion algorithm 512. Then, based on a judgment mode 614, the controller 112 determines whether the variance 606 and the average value 608 meet the discrete condition, or determines whether the state 612 is a stationary state, or whether the current opening angle 602 is within the closed angle range of the foldable device 100. When the controller 112 determines that at least one of the above conditions is met, it enters the power saving mode 616, thereby turning off the gyroscope.

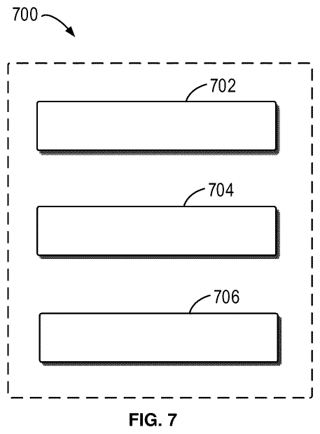

FIG. 7 is a block diagram of an apparatus 700 for detecting a rotation angle of a foldable device according to some examples of the present disclosure, wherein the foldable device comprises a first movable part and a second movable part that rotate through a connecting member. The apparatus 700 comprises a rotation speed acquisition module 702 configured to acquire a first rotation speed of the first movable part and a second rotation speed of the second movable part. The apparatus 700 further comprises a difference comparison module 704 configured to determine whether the difference between the first rotation speed and the second rotation speed is higher than a first difference threshold. Furthermore, the apparatus 700 also comprises a rotation angle determination module 706 configured to respond when the difference between the first rotation speed and the second rotation speed is higher than the first difference threshold and determine a rotation angle between the first movable part and the second movable part based on the first rotation speed and the second rotation speed.

In some examples, the apparatus 700 further comprises a non-existence rotation angle determination module configured to respond when the difference between the first rotation speed and the second rotation speed is lower than the first difference threshold and determine that the rotation angle does not exist.

In some examples, the non-existence rotation angle determination module is further configured to respond when the difference between the first rotation speed and the second rotation speed is lower than the second difference threshold, and/or the rate of change of the difference between the first rotation speed and the second rotation speed is lower than the rate of change threshold and determine that the rotation angle does not exist, wherein the second difference threshold is lower than or equal to the first difference threshold.

In some examples, a first gyroscope is disposed in the first movable part, a second gyroscope is disposed in the second movable part, the first rotation speed comprises a first angular velocity obtained by the first gyroscope, the second rotation speed comprises a second angular velocity obtained by the second gyroscope, and the rotation angle determination module 706 is further configured to determine a first time period corresponding to the first angular velocity and a second time period corresponding to the second angular velocity; determine a first rotation angle based on the first angular velocity and the first time period, and determine a second rotation angle based on the second angular velocity and the second time period; and determine the rotation angle based on the first rotation angle and the second rotation angle.

In some examples, a first acceleration sensor is provided in the first movable part, and a second acceleration sensor is provided in the second movable part, and the apparatus 700 further comprises a stationary state determination module, configured to determine whether the first movable part and the second movable part are in a stationary state by using the first acceleration sensor and the second acceleration sensor; a compensation value acquisition module, configured to respond when the first movable part and the second movable part are in a stationary state and obtain a first compensation value for the first gyroscope and a second compensation value for the second gyroscope; and an angular velocity adjustment module, configured to adjust the first angular velocity and the second angular velocity based on the first compensation value and the second compensation value.

In some examples, the apparatus 700 further comprises a first compensation value determination module, configured to obtain multiple angular velocities of the first movable part at multiple time points by the first gyroscope when the first movable part is in a stationary state; and determine the first compensation value based on the average value of the multiple angular velocities.

In some examples, the first movable part is provided with a first gyroscope, a first acceleration sensor and a magnetic sensor, the second movable part is provided with a second gyroscope, a second acceleration sensor and a permanent magnet, the first rotation speed is obtained by the first gyroscope, and the second rotation speed is obtained by the second gyroscope, and the apparatus 700 further comprises a first angle determination module, configured to determine the first angle between the first movable part and the second movable part by the first acceleration sensor and the second acceleration sensor; a second angle determination module, configured to determine the second angle between the first movable part and the second movable part by the magnetic sensor and the permanent magnet; and an angle determination module, configured to determine the angle of the foldable device based on the state of the foldable device and at least one of the following: the first angle, the second angle, and the rotation angle.

In some examples, the angle determination module is further configured to determine the angle of the foldable device as a first angle when the foldable device is in a stationary state and the angle between the connecting member and the horizontal plane is lower than the angle threshold; to determine the angle of the foldable device as a second angle when the foldable device is in a closed state; and to determine the angle of the foldable device based on the rotation angle when the foldable device is in motion.

In some examples, the angle determination module is further configured to, when the foldable device is in motion, obtain the angle of the foldable device at a first time point, wherein the first time point is the time point when the foldable device enters the motion state; and determine the angle of the foldable device based on the angle at the first time point and the rotation angle.

In some examples, the apparatus 700 further comprises a disabling module configured to disable the first gyroscope and the second gyroscope when the foldable device is in a stationary state or a closed state, or when the discrete degrees of multiple angles of the foldable device meet discrete conditions; or an activation module configured to activate the first gyroscope and the second gyroscope in response to the foldable device being in motion.

It will be understood that the apparatus 700 of the present disclosure may achieve at least one of a number of advantages that the method or process described above can achieve. For example, the apparatus 700 can collect the rotation speeds of the two moving parts and perform a threshold judgment on the rotation speed difference of the two moving parts. When the difference is higher than the difference threshold, the rotation angle between the two movable parts is determined based on the rotation speeds of the two movable parts. In this way, the rotation angle is calculated when the rotation speed difference between the two movable parts meets a threshold condition. This approach helps avoid the rotation angle within a certain error range caused by the zero point offset and sensitivity deviation of sensors when the opening angle between the two movable parts should remain unchanged. As a result, the accuracy of the opening angle is improved, enhancing the user experience of the foldable device.

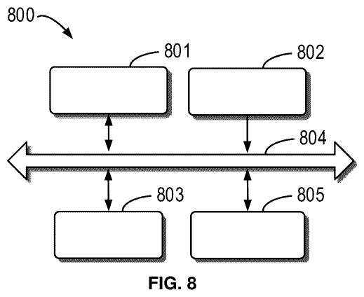

FIG. 8 is a schematic block diagram of a controller 800 that may be used to implement the examples of the present disclosure. In some examples, the controller 800 is used to implement the controller 112 shown in the foldable device 100 of FIG. 1. As shown in FIG. 8, the controller 800 comprises a processor 801, which can perform various appropriate actions and processes according to machine program instructions stored in a read-only memory (ROM) 802 and loaded into a random-access memory (RAM) 803. Various programs and data required for the operation of the controller 800 may also be stored in the RAM 803. The processor 801, the ROM 802, and the RAM 803 are interconnected through a bus 804. An input/output (I/O) interface 805 is also connected to the bus 804.

The various processes and processing described above, such as the method 300, the process 400, the process 500, and the process 600, may be executed by processor 801. For example, in some examples, the method 300, the process 400, the process 500, and the process 600 may be implemented as a machine software program tangibly contained in a machine-readable medium. In some examples, part or all of the machine program may be loaded and/or installed onto the controller 800 through the ROM 802. When the machine program is loaded onto the RAM 803 and executed by the processor 801, one or more actions of the method 300, the process 400, the process 500, and the process 600 described above may be performed.

The present disclosure may be a method, an apparatus, a system, and/or a machine program product. The machine program product may comprise a machine-readable storage medium carrying machine-readable program instructions for performing various aspects of the present disclosure.

The machine-readable storage medium may be a tangible device that maintains and stores instructions used to instruct execution devices. The machine-readable storage medium, for example, may be—but is not limited to—an electrical storage device, magnetic storage device, optical storage device, electromagnetic storage device, semiconductor memory device, or any suitable combination of the above. More specific examples of the machine-readable storage medium (a non-exhaustive list) comprise: random access memory (RAM), read-only memory (ROM), erasable programmable read-only memory (EPROM or flash memory), static random access memory (SRAM), and any suitable combination of the above. The machine-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

The machine-readable program instructions described herein may be downloaded from a machine-readable storage medium to various computing/processing devices, or downloaded to external machines or external storage devices from networks, such as the Internet, a local area network, a wide area network, and/or a wireless network. The networks may comprise copper transmission cables, fiber optic transmissions, wireless transmissions, routers, firewalls, switches, gateway machines and/or edge servers. The network adapter card or network interface in each computing/processing device receives the machine-readable program instructions from the network and forwards the machine-readable program instructions for storage in a machine-readable storage medium of each computing/processing device.

The machine program instructions used to execute the operations of the present disclosure may be assembly instructions, instructions set architecture (ISA) instructions, machine instructions, machine-related instructions, microcode, firmware instructions, state-setting data, or source code or object code written with any combination of one or many programming languages, with the programming languages including object-oriented programming languages such as Smalltalk, C++, etc., as well as conventional procedural programming languages such as “C” language or similar programming languages. The machine-readable program instructions may execute entirely on the user's machine, partly on the user's machine, as a stand-alone software package, partly on the user's machine and partly on a remote machine or entirely on the remote machine or server. Where a remote machine is involved, the remote machine may be connected to the user's machine through any type of network, including a local area network (LAN) or a wide area network (WAN), or may be connected to an external machine (e.g., through the Internet using an Internet service provider). In some examples, the state information of machine-readable program instructions is used to personalize electronic circuits, such as a programmable logic circuit, a field-programmable gate array (FPGA), or a programmable logic array (PLA), wherein the electronic circuit is able to execute machine-readable program instructions, thereby achieving the various aspects of the present disclosure.

Various aspects of the present disclosure are described herein with reference to flow charts and/or block diagrams depicting the method, apparatus (system), and machine program product according to the examples of the present disclosure. It should be understood that every block in the flow charts and/or block diagrams and the combinations of various blocks in the flow charts and/or block diagrams may be implemented by machine-readable program instructions.

These machine-readable program instructions may be provided to a processing unit of a general-purpose machine, a special-purpose machine, or other programmable data processing devices to produce a machine such that when these instructions are executed by the processing unit of the machine or other programmable data processing devices, a device is generated that implements the functions/actions specified in one or more blocks in the flow charts and/or block diagrams. These machine-readable program instructions may also be stored in a machine-readable storage medium, and these instructions cause the machine, programmable data processing devices, and/or other equipment to work in a specific manner. Therefore, the machine-readable medium storing the instructions comprises a manufactured product that comprises instructions for implementing various aspects of the functions/actions specified in one or more blocks in the flow charts and/or block diagrams.

The machine-readable program instructions may also be loaded onto a machine, other programmable data processing devices, or other devices, enabling a series of operational steps to be executed on the machine, other programmable data processing devices, or other devices to generate a machine-implemented process. This enables the instructions executed on the machine, other programmable data processing devices, or other devices to implement the functions/actions specified in one or more blocks in the flow charts and/or block diagrams.

The flow charts and block diagrams in the accompanying drawings show the system architecture, functions and operations that may be implemented based on the system, method and machine program product according to the plurality of examples of the present disclosure. Regarding this, every block in the flow chart or block diagram can represent a part of a module, program section or instructions, wherein the part of the module, program section or instructions contains one or a plurality of executable instructions that are used to implement the stipulated logic function. In some alternative implementations, the occurrence of the function indicated in the blocks may also differ from the sequence indicated in the accompanying drawings. For example, two continuous blocks may actually be substantially performed in a concurrent manner and they may also sometimes be performed in reverse order, depending on the functions involved. It must also be noted that every block in the block diagrams and/or flow charts, as well as combinations of blocks in the block diagrams and/or flow charts may be implemented by dedicated hardware-based systems used to perform the stipulated functions or actions, or implemented by using combinations of dedicated hardware and machine instructions.

The various examples of the present disclosure have been described above. The descriptions provided are exemplary and not exhaustive, and they are also not limited to the disclosed examples. Many modifications and variations will be apparent to those skilled in the art without departing from the scope and spirit of the described examples. The selection of terms used herein aims to best explain the principles and actual applications of various examples as well as the technological improvements in the technology in the market, or allow others of ordinary skill in the art to understand various examples disclosed herein.

What is claimed is:

1. A method for detecting a rotation angle of a foldable device, wherein the foldable device includes a first movable part and a second movable part that rotate through a connecting member, the method comprising:
obtaining a first rotation speed of the first movable part and a second rotation speed of the second movable part;
determining whether a difference between the first rotation speed and the second rotation speed is higher than a first difference threshold; and
responding when the difference between the first rotation speed and the second rotation speed is higher than the first difference threshold and determining a rotation angle between the first movable part and the second movable part based on the first rotation speed and the second rotation speed.

2. The method according to claim 1, further comprising:
responding when the difference between the first rotation speed and the second rotation speed is lower than the first difference threshold and determining that the rotation angle does not exist.

3. The method according to claim 1, wherein determining that the rotation angle does not exist comprises:
responding when the difference between the first rotation speed and the second rotation speed is lower than a second difference threshold, and/or the rate of change of the difference between the first rotation speed and the second rotation speed is lower than a rate of change threshold and determining that the rotation angle does not exist, wherein the second difference threshold is lower than or equal to the first difference threshold.

4. The method according to claim 1, wherein the first movable part is provided with a first gyroscope, the second movable part is provided with a second gyroscope, the first rotation speed comprises a first angular velocity obtained by the first gyroscope, the second rotation speed comprises a second angular velocity obtained by the second gyroscope, and based on the first rotation speed and the second rotation speed, determining the rotation angle between the first movable part and the second movable part comprises:
determining a first time period corresponding to the first angular velocity and a second time period corresponding to the second angular velocity;
determining a first rotation angle based on the first angular velocity and the first time period, and determining a second rotation angle based on the second angular velocity and the second time period; and
determining the rotation angle based on the first rotation angle and the second rotation angle.

5. The method according to claim 4, wherein a first acceleration sensor is provided in the first movable part, a second acceleration sensor is provided in the second movable part, and the method further comprises:
determining whether the first movable part and the second movable part are in a stationary state by the first acceleration sensor and the second acceleration sensor;
responding when the first movable part and the second movable part are in a stationary state and obtaining a first compensation value for the first gyroscope and a second compensation value for the second gyroscope; and
adjusting the first angular velocity and the second angular velocity based on the first compensation value and the second compensation value.

6. The method according to claim 5, wherein the method for determining the first compensation value comprises:
obtaining multiple angular velocities of the first movable part at multiple time points by the first gyroscope when the first movable part is in a stationary state; and
determining the first compensation value based on the average value of the multiple angular velocities.

7. The method according to claim 1, wherein the first movable part is provided with a first gyroscope, a first acceleration sensor and a magnetic sensor, the second movable part is provided with a second gyroscope, a second acceleration sensor and a permanent magnet, the first rotation speed is obtained by the first gyroscope, the second rotation speed is obtained by the second gyroscope, and the method further comprises:
determining a first angle between the first movable part and the second movable part by the first acceleration sensor and the second acceleration sensor;
determining a second angle between the first movable part and the second movable part by the magnetic sensor and the permanent magnet; and
determining the angle of the foldable device based on the state of the foldable device and at least one of the following: the first angle, the second angle and the rotation angle.

8. The method according to claim 7, wherein determining the angle of the foldable device based on the state of the foldable device and one of the following: the first angle, the second angle, and the rotation angle, comprises:
determining the angle of the foldable device to be the first angle when the foldable device is in a stationary state and the angle between the connecting member and the horizontal plane is lower than an angle threshold;
determining the angle of the foldable device to be the second angle when the foldable device is in a closed state; and
determining the angle of the foldable device based on the rotation angle when the foldable device is in motion.

9. The method according to claim 8, wherein determining the angle of the foldable device based on the rotation angle when the foldable device is in motion, comprises:
obtaining the angle of the foldable device at a first time point when the foldable device is in motion, the first time point being the time point when the foldable device enters the motion state; and
determining the angle of the foldable device based on the angle at the first time point and the rotation angle.

10. The method according to claim 8, further comprising:
disabling the first gyroscope and the second gyroscope when the foldable device is in a stationary state or a closed state, or when the discrete degrees of multiple angles of the foldable device meet discrete conditions; or
responding when the foldable device is in motion and starting the first gyroscope and the second gyroscope.

11. An apparatus for detecting a rotation angle of a foldable device, wherein the foldable device comprises a first movable part and a second movable part that rotate through a connecting member, the apparatus comprising:
a rotation speed acquisition module configured to acquire a first rotation speed of the first movable part and a second rotation speed of the second movable part;
a difference comparison module configured to determine whether the difference between the first rotation speed and the second rotation speed is higher than a first difference threshold; and
a rotation angle determination module configured to respond when the difference between the first rotation speed and the second rotation speed is higher than the first difference threshold and determine a rotation angle between the first movable part and the second movable part based on the first rotation speed and the second rotation speed.

12. A controller, comprising:
at least one processor, and
a memory, coupled to the at least one processor, and having instructions stored thereon, wherein the instructions, when executed by the at least one processor, cause the controller to perform the method according to claim 1.

13. A foldable device, comprising:
a first movable part and a second movable part that rotate through a connecting member;
a first gyroscope disposed on the first movable part and a second gyroscope disposed on the second movable part;
a first acceleration sensor disposed on the first movable part and a second acceleration sensor disposed on the second movable part;
a magnetic sensor disposed on the first movable part and a permanent magnet disposed on the second movable part; and
the controller according to claim 12.

14. A computer program product, comprising a computer program, wherein the computer program is executed by a processor to implement the method according to claim 1.
